(19) United States
(12) Patent Application Publication
(10) Pub. No.: US 2023/0227050 A1
(43) Pub. Date: Jul. 20, 2023

(54) METHOD FOR PROCESSING SENSOR DATA

(71) Applicant: Robert Bosch GmbH, Stuttgart (DE)

(72) Inventors: Christopher Herbon, Weil Im Schoenbuch (DE); Michael Miksch, Renningen (DE); Stephan Lenor, Gerlingen (DE)

(21) Appl. No.: 18/154,140

(22) Filed: Jan. 13, 2023

(30) Foreign Application Priority Data
Jan. 18, 2022 (DE) 10 2022 200 482.5
Sep. 9, 2022 (DE) 10 2022 209 406.9

(51) Int. Cl. B60W 50/02; B60W 60/00; H04N 17/00

(52) U.S. Cl. CPC B60W 50/0205; B60W 60/001; H04N 17/002; B60W 2420/42; B60W 2050/021

(57) ABSTRACT

A method for processing sensor data in a system that includes multiple sensors for detecting at least a subarea of surroundings around the system. The method includes at least the following steps: a) reading in sensor data detected at least partially in parallel, b) checking whether an at least partial impairment of the detection by the respective sensor may be established for one or for multiple of the sensors on the basis of the read-in sensor data, c) adapting the use of the sensor data, taking the check from step b) into account.

### CROSS REFERENCE

The present application claims the benefit under 35 U.S.C. § 119 of German Patent Application Nos. DE 10 2022 200 482.5 filed on Jan. 18, 2022, and DE 10 2022 209 406.9 filed on Sep. 9, 2022, which are expressly incorporated herein by reference in their entireties.

### FIELD

The present invention relates to a method for processing sensor data in a system that includes multiple sensors for detecting at least a subarea of surroundings around the system. In addition, a computer program for carrying out the method, a machine-readable memory medium, on which the computer program is stored, and a system, in particular, for a vehicle drivable in a preferably at least semi-assisted and/or automated manner are specified. The present invention may be applied, in particular, in connection with the at least semi-automated or autonomous driving.

### BACKGROUND INFORMATION

Camera sensors are a standard component of modern robotics systems and assistance systems. The sensors and the optical path for image detection in such systems are exposed as a rule to degrading surroundings influences and aging processes. Depending on safety and availability requirements, it is advantageous that such sensor failures are taken into account in the system design.

One example is the use of cameras in motor vehicles. In this case, they may be used to implement driver assistance functions (SAE Level 1-2) and (semi-)autonomous driving (SAE Level 3-5). There are diverse influences that may degrade an automobile camera, among others, contamination, icing, drops, condensation, glare, stone impacts, hardware failures, communication errors, etc. Since faulty actuation in road traffic may rapidly result in substantial risks, the safety requirements with regard to handling sensor degradation are typically very strict. In contrast thereto, there may be noticeable differences in the requirements with regard to availability of driver assistance systems and autonomous driving. With increasing automation, it is possible to eliminate the human driver as a quickly available and safe fallback level. Accordingly, the maximization of the sensor (and consequently system) availability may increase substantially in importance and may justify a significant increase in the use of hardware and engineering.

In current systems of each SAE level, system functions are statically assigned to particular individual video camera sensors or camera networks. For example, an emergency brake application in the case of crossing pedestrians or cyclists is typically triggered based on image data of a camera in the vehicle facing forward, whereas laterally aligned cameras are designed in large part for recognizing other vehicles. Examples of camera networks are also combinations made up of wide-angle and tele-cameras in order, for example, to be able to reliably detect traffic lights both in the distance as well as nearby, or a camera belt, in which objects are able to be simultaneously detected and localized across all camera images.

Stereo cameras represent a further feature, in which two cameras are operated horizontally offset in approximately the same viewing direction and fixedly connected to one another. The spacing between the cameras is usually 10 cm to 30 cm. Using this arrangement, it is possible to generate with the aid of the so-called stereo disparity a three-dimensional reconstruction of the imaged scene. A network of more than two cameras is also possible (cf. FIG. 2).

In current systems, one of the two stereo image sensors is used solely as a second viewing angle on the scene in order to enable a depth estimation. All other functions (for example, ego-motion estimation, semantic segmentation, object recognition) build exclusively on the image data stream of the first sensor. This imaging data path is usually referred to and is referred to below as a main data path. Depending on the integration concept it is in part even common for a stereo camera as an interface for further processing to offer only one image and the depth map—the second image in this case is not available.

In general, it is presently not common to install cameras solely for the purpose of failure redundancy. Accordingly, each installed camera in a multisensory network is usually used for at least one dedicated system application. Each failure may accordingly result in a functional limitation.

In addition to preferably precise detection of failures (for example, by blindness recognition) and a preferably safe system behavior, it is frequently a goal, in particular, with increasing automation, to maximize the availability of the system functions in the case of existing sensor failures. In this case, the method described herein may offer an important contribution.

A further goal may be considered to be increasing the availability of sensor data such as, for example video data, in a (robotics or assistance) system using a modified system design, which is equipped with multiple sensors such as, for example, cameras.

### SUMMARY

The goals and objects may be achieved or solved with the features of the present invention. Advantageous embodiments of the present invention are disclosed herein.

Contributing to this purpose is a method for processing sensor data in a system that includes multiple sensors for detecting at least a subarea of surroundings around the system. According to an example embodiment of the present invention, the method includes at least the following steps:
a) reading in sensor data detected at least partially in parallel,
b) checking whether an at least partial impairment of the detection by the respective sensor may be established for one or for multiple of the sensors on the basis of the read in sensor data,
c) adapting the use of the sensor data, taking the check from step b) into account.

Steps a), b), and c) may be carried out, for example, at least once and/or repeatedly in the order indicated for carrying out the method. Steps a), b), and c), in particular, steps b) and c), may further be carried out at least partially in parallel or simultaneously.

The method according to the present invention may be used, in particular, for a preferably precise detection of failures (for example, by blindness recognition), which may contribute to a preferably safe system behavior. The method may further advantageously contribute to preferably maximizing the availability of the system functions in the case of existing sensor failures. In addition, the method may make it possible to advantageously increase the availability of sensor data such as, for example, video data, in a (robotics or assistance) system. The method may advantageously contribute to an availability-based selection of a main image data stream with application for (semi-) automated driving.

The advantages described may be achieved according to one particularly advantageous embodiment of the present invention by calculating for each of the installed (image) sensors a potential blindness or degradation, on the basis of which the continued use of the data streams or image streams may be adapted. Of particular advantage for the adapted system design is the fact that two or more cameras detect sufficiently similar sections of the surroundings, so that they are at least partially redundant.

According to an example embodiment of the present invention, in step a), a reading in of sensor data detected at least partially in parallel takes place. In this case, sensor data detected, in particular, temporally at least partially in parallel are read in. The reading in may further take place preferably based on different, in particular at least partially parallel, sensor data streams. The reading in may further take place by sensors that have, in particular, at least partially overlapping detection areas.

According to an example embodiment of the present invention, in step b), a check of whether an at least partial impairment of the detection by the respective sensor may be established for one or for multiple of the sensors takes place on the basis of the read-in sensor data. In this case, it may be checked, in particular, whether an at least partial blindness of the respective sensor may be established for one or for multiple of the sensors on the basis of the read-in sensor data.

According to an example embodiment of the present invention, in step c), an adaptation of the sensor data takes place taking the check from step b) into account. In this case, a selection of a main sensor data stream or sensor data stream for a main data path of the system from the different sensor data streams may, in particular, take place.

According to one advantageous embodiment of the present invention, it is provided that one or multiple of the sensors are camera sensors. For example, one or multiple of the sensor data streams may be image data streams. In step a), in particular, different image data streams from different camera sensors detected, in particular, temporally at least partially in parallel may be read in.

According to one further advantageous embodiment of the present invention, it is provided that the check in step b) takes place on the basis of a comparison of detections by different sensors. For example, the check in step b) may take place on the basis of a comparison of at least partially redundant detections by different sensors.

According to one further advantageous embodiment of the present invention, it is provided that a provision of at least one piece of information about:
a or the selected (main) sensor data stream, and/or
an established impairment of the detection, and/or
a position of the sensor for one or for the main data path changed due to the selection takes place.

For example, a corresponding provision may take place in an (optional) step d) of the method.

According to one further advantageous embodiment of the present invention, it is provided that the sensors are the two visual sensors of a stereo camera.

According to one further advantageous embodiment of the present invention, it is provided that the sensor data or sensor data streams are processed at least partially separately from one another. In this connection, for example, the sensor data or sensor data streams may be checked at least partially separately from one another.

According to one further advantageous embodiment of the present invention, it is provided that the system is a system for at least semi-assisted and/or automated driving.

According to one further aspect of the present invention, a computer program is specified for carrying out a method as described herein. In other words, this relates to a computer program (product) including commands which, when the program is executed by a computer, prompt the computer to carry out a method described herein.

According to one further aspect of the present invention, a machine-readable memory medium is specified, on which the computer program is stored. The machine-readable memory medium is regularly a computer-readable data medium.

According to one further aspect of the present invention, a system is specified, including at least:
multiple sensors for the, in particular, temporally at least partially parallel detection of at least one subarea, in particular, of at least partially overlapping detection areas of surroundings around the system, the sensors being able to provide the detected sensor data preferably in the form of sensor data streams via data paths extending at least partially separately from one another,
one or multiple units for checking whether an at least partial impairment of the detection by the respective sensor, in particular, an at least partial blindness of the respective sensor, may be established for one or for multiple of the sensors on the basis of the sensor data detected by the sensors,
a unit for selecting a main sensor data stream or sensor data stream including, in particular, a switch for switching between the different sensor data streams or data paths.

According to an example embodiment of the present invention, the system may, for example, be a system for a vehicle drivable preferably in at least a partially assisted and/or automated manner. The vehicle may, for example, be a motor vehicle such as, for example, an automobile. The system may preferably be configured to carry out a method described herein.

The details, features and advantageous embodiments discussed in conjunction with the method of the present invention may accordingly also appear in the computer program presented herein, in the memory medium and/or in the system and vice versa. In this respect, reference is made in full to the explanations there for a more detailed characterization of the features.

The approach presented herein as well as its technical environment is explained in greater detail below with reference to the figures. It should be noted that the present invention is not intended to be restricted by the exemplary embodiments shown. In particular, it is also possible, unless explicitly represented otherwise, to extract partial aspects of the actual situation explained in the figures and to combine them with other elements and/or findings from other figures and/or from the present description.

### BRIEF DESCRIPTION OF THE DRAWINGS

FIG. 1 schematically shows an exemplary flowchart of a method according to the present invention presented herein.

FIG. 2 schematically shows an exemplary potential application of the method according to the present invention presented herein.

FIG. 3 schematically shows an illustration of one exemplary situation, in which the method according to the present invention presented herein may be advantageously applied.

FIG. 4 schematically shows an exemplary flowchart of one advantageous embodiment variant of the method presented herein, and

FIG. 5 schematically shows an exemplary design of one advantageous embodiment variant of the system according to the present invention presented herein.

### DETAILED DESCRIPTION OF EXAMPLE EMBODIMENTS

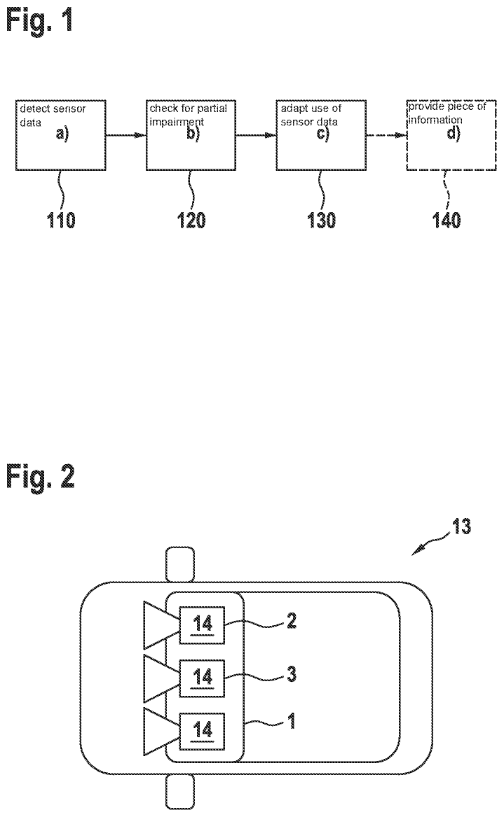

FIG. 1 schematically shows an exemplary flowchart of a method presented herein. The method is used for processing sensor data in a system 1 that includes multiple sensors 2, 3 for detecting at least one subarea of surroundings around system 1. The order of steps a), b), and c) represented by blocks 110 and 120, and 130 is exemplary and may, for example, be run through at least once in the order represented for carrying out the method.

In block 110, sensor data detected, in particular, temporally at least partially in parallel are read in according to step a), preferably from different, in particular, at least partially parallel sensor data streams, by sensors 2, 3 having, in particular, at least partially overlapping detection areas 4, 5.

In block 120, a check takes place according to step b) as to whether an at least partial impairment of the detection by respective sensors 2, 3, in particular, an at least partial blindness of respective sensors 2, 3 may be established for one or for multiple of sensors 2, 3 on the basis of the read-in sensor data.

In block 130, an adaptation of the use of the sensor data takes place according to step c) taking the check from step b) into account, a selection of a main sensor data stream or sensor data stream for a main data path 11 of system 1 from the different sensor data streams, in particular, taking place.

For example, one or multiple of sensors 2, 3 may be camera sensors and/or one or multiple of the sensor data streams may be image data streams.

Optionally, a provision of at least one piece of information about:
the selected (main) sensor data stream, and/or
an established impairment of the detection, and/or
a position of sensor 2, 3 for main data path 11 changed due to the selection

may take place in block 140 according to step d).

For example, the sensor data or sensor data streams may be processed, in particular, checked, at least partially separately from one another. Furthermore, system 1 may be a system for at least semi-assisted and/or automated driving (cf. FIG. 2).

FIG. 2 schematically shows one exemplary potential application of the method presented herein. In this context, FIG. 2 shows by way of example and schematically a top view onto a vehicle 13 including three cameras 14, which are mounted behind the windshield and face forward. At least two of cameras 14 may, for example, be used as sensors 2, 3 for the method described herein.

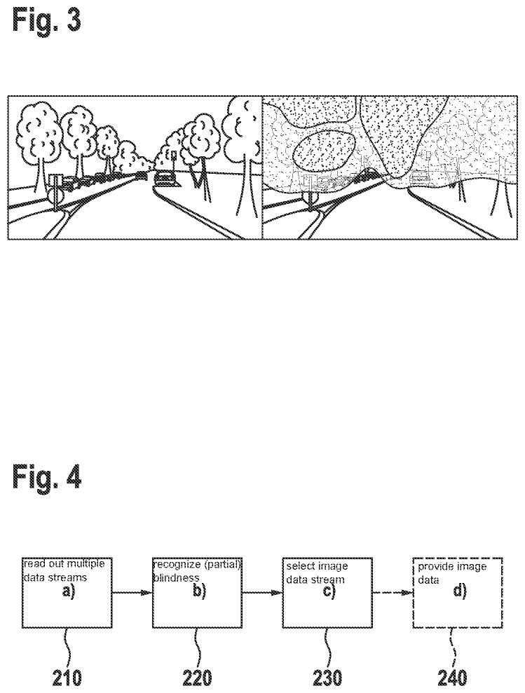

FIG. 3 schematically shows an illustration of one exemplary situation, in which the method presented herein may be advantageously used. In this context, FIG. 3 shows an example of one-sided blindness of a stereo imager pair. The left imager has a clear view, whereas the right imager is largely blind as a result of rain. An “imager” here describes an example of an optical sensor or image sensor. The stereo image pair may be part of a stereo camera.

Thus, FIG. 3 also illustrates an example of the fact that, and optionally of how, sensors 2, 3 may be the two optical sensors of a stereo camera. Furthermore, FIG. 3 also shows an example of the fact that, and optionally of how, the check in step b) may take place on the basis of a comparison of, in particular, at least partially redundant detections of different sensors 2, 3.

FIG. 4 schematically shows an exemplary flowchart (block diagram) of one advantageous embodiment variant of the method presented herein. The method may include multiple, here, for example four, steps.

In block 210, a reading out of multiple data streams may take place. This may represent an example of the fact that, and optionally of how, according to step a) a reading in of sensor data detected at least partially in parallel may take place.

A reading in of image data streams in particular, may take place. In this case, an arbitrary number of temporally synchronous image data streams may be read in. The number may range from two up to a dozen or more data streams.

In block 220, a recognition of the (partial) blindness for each image data stream may take place. This may represent an example of the fact that, and optionally of how, according to step b) a check may take place as to whether an at least partial impairment of the detection by respective sensor 2, 3 may be established for one or for multiple of sensors 2, 3 on the basis of the read-in sensor data.

A blindness for each image data stream may be established, in particular, individually (cf. below regarding failure recognition). A blindness in the technical sense may also be present here, in particular, when random or persistent hardware errors occur. These may come about as a result of aging, cosmic radiation or mechanical damage.

In block 230, a selection of an image data stream for the main data path may take place. This may represent an example of the fact that, and optionally of how, according to step c) an adaptation of the use of the sensor data may take place taking the check from step b) into account.

The main image data stream may be selected, in particular, on the basis of the blindness. In the case of more than two image data streams, further, supplemental data streams may be selected, for example, for a stereo disparity.

If only a partial blindness is present, system functions that normally require multiple image data streams may advantageously also be partially maintained. For this purpose, additional data paths may be selected in such a way that the residual information content is preferably large. This may also take place on the basis of further pieces of information. For a stereo system, for example, the image sensor whose blindness in the area of the road or of other relevant regions is preferably minimal, may be particularly important as a secondary data stream.

In block 240, a provision of the image data, position of the camera, and blindness status in the system may take place. This may represent an example of the fact that, and optionally of how, according to an optional step d) a provision of at least one piece of information about:
the selected (main) sensor data stream, and/or
an established impairment of the detection, and/or
a position of sensor 2, 3 for main data path 11 changed due to the selection

may take place.

The information about the selected data streams, in particular, may be provided in the system. In addition, data about the blindness per se and about the change of the camera position of the main data path may be advantageously sent or provided. The changed camera position, in particular, may be an advantageous piece of information for the entire system, for example, for assigning calibration data and for algorithms for depth reconstruction.

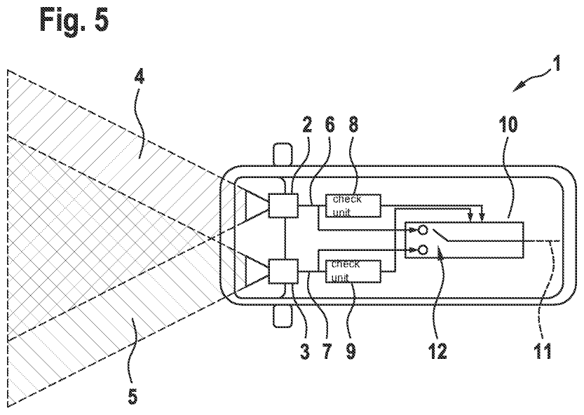

FIG. 5 schematically shows an exemplary design of one advantageous embodiment variant of system 1 presented herein. In this context, FIG. 5 shows by way of example and schematically a selection of main data path 11 in a stereo system. The blindness ascertained by way of example advantageously serves as a control variable for the selection of the main data stream.

System 1 is suitable, in particular, for a vehicle drivable preferably at least in a semi-assisted and/or automated manner. System 1 is configured, in particular, for carrying out a method presented herein.

System 1 includes multiple sensors 2, 3 for the, in particular, temporally at least partially parallel detection of at least one subarea, in particular, of at least partially overlapping detection areas 4, 5 of surroundings around system 1, the sensors 2, 3 being able to provide the detected sensor data preferably in the form of sensor data streams via data paths 6, 7 extending at least partially separately from one another.

System 1 includes one or multiple units 8, 9 for checking whether an at least partial impairment of the detection by relevant sensors 2, 3, in particular, an at least partial blindness of respective sensors 2, 3, may be established for one or for multiple of sensors 2, 3 on the basis of the sensor data detected by sensors 2, 3.

System 1 includes a unit 10 for selecting a main sensor data stream or sensor data stream for a main data path 11, in particular, including a switch 12 for switching between the different sensor data streams or data paths 6, 7.

System 1 may advantageously adequately degrade relative to the remaining sensor availability.

Camera systems may be used, in which cameras 14 (cf. FIG. 2) do not face forward or face forward not exclusively in parallel to one another. Thus, for example, laterally aligned cameras, which look forward only to a small extent, may partially compensate for a blind front camera. A camera belt may preferably be used.

According to one particularly preferred embodiment variant, an availability-based selection of the main image data stream, in particular, with application for (semi-)automated driving, may be specified.

Possible options for a failure recognition are described below:

For advantageously assuring the function of a camera system 1, including one or multiple cameras 14, it may be checked for each image sensor 2, 3 at regular intervals whether a clear view of the surroundings is present. This may include, for example, a recognition of external disruptions in the sight path (blindness) or recognition of technical defects (hardware errors). Both cases may result in a partial or complete failure or of a degradation of camera 14. Failures may be permanent or temporary. In the case of a sensor failure, system 1 may advantageously adequately degrade, for example, may cease functioning partially or entirely (cf. FIG. 3).

Depending on how granularly camera degradation is measured (for example, in time, location, cause and effect) and how reliably that occurs, a more or less granular system degradation may be implemented.

A blindness recognition may be implemented in different ways. One possible approach is the observation of the movement in a scene. Simply put, when a movement is present in the image or in sections of the image, a clear view may be assumed. Conversely, however, the absence of movement is not indicative of a blindness. A lack of movement is thus by way of example merely a necessary but not a sufficient condition.

One further approach is the classification of blindness with the aid of a neural network (for example, via deep learning). For this purpose, training data of image sequences having complete, partial or non-existing blindness may be used in order to teach a neural network precisely these states.

For overlapping image sections, the comparison of two image data streams may also be particularly advantageously utilized. If the observed scene between two data streams with overlapping fields of view 4, 5 is different, this is a particularly advantageous indicator of a blindness.

In the case of a degradation of a driver assistance system caused by blindness, the driver may immediately take control of vehicle 13. Each degradation may represent a loss of comfort and thus a loss of customer benefit, but also safety functions such as an emergency brake application then may no longer be available. Worse still, a degradation may affect highly automated systems. In the worst case, it may result here in an abort of the driving operation.

For this reason, the maximization of the system availability gains increasingly in importance. In the case of systems including partially redundant information sources, in particular, such as for example, in a stereo camera, it is advantageous to prevent or mitigate the system degradation in the case of a partial blindness by advantageously utilizing the redundant data source.

One preferred embodiment variant is formed here by a stereo camera (cf. FIG. 5). A stereo camera (system 1 in FIG. 5), in which the main data path 11 may be switched between left and right imagers 2, 3 in accordance with a blindness signal, is particularly preferred.

In other words, this relates, in particular, to a stereo camera, in which the main image data stream may alternate between left and right sensor 2, 3 on the basis of the blindness. An exemplary data flow is illustrated in FIG. 5. The blindness information advantageously serves as a control variable for the switching of the main image data stream.

In this embodiment variant, it is further advantageous that camera sensors 2, 3 have a large or nearly complete overlapping area. The redundant image information here may be particularly advantageously utilized, resulting in a particularly major advantage for the image data availability.

A combination including a hardware separation may be provided as a further embodiment variant. One further possibility of improving the system design with respect to availability is to preferably separate the post-processing of the partially redundant image data streams in the hardware. Using a combination including a processing switch 12 of the image data streams, it is possible as a result to advantageously lower the safety load on the hardware.

In this regard, an explanation based on the stereo example: Even without a switch concept (classical), it may be worth separating the hardware paths, but then an increased safety load may remain on the hardware, which then processes main image path 11—if this fails, image and depth are normally gone. Using a switch concept, a hardware separation may be advantageously improved, because the failure of the hardware may be partially compensated for by the redundant path as a result. If the hardware of main image path 11 fails, the image may be retained via switch 12 and the second path.

One advantage of the method described is the increased availability of video data. A system degradation in the case of an individual blind or partially blind image sensor 2, 3 may be advantageously mitigated. In this way, system functions may, if necessary, be maintained or a safer degradation behavior may be implemented.

This is advantageous, in particular, for highly autonomous systems, for example, in the area of autonomous driving, where the vehicle occupants temporarily or fully surrender control to the vehicle. The autonomous system may thus potentially still complete missions, if necessary, using modified planning, or may also merely maintain the safety for achieving a safe state. The switch system described may be particularly advantageous for a preferably safe management of one-sided blindness.

In the area of driver assistance as well, the method may provide an additional customer benefit as a result of the increased availability, in particular, through increased comfort and greater availability in safety functions, for example, emergency brake application or automatic avoidance of obstacles.

In certain system designs, the method described herein could also serve as an alternative to the equipping of a cleaning system, or favor the choice of a weaker cleaning system.

What is claimed is:

1. A method for processing sensor data in a system that includes multiple sensors for detecting at least one subarea of surroundings around the system, comprising the following steps:
a) reading in sensor data detected at least partially in parallel by the sensors;
b) checking, on the basis of the read-in sensor data, whether an at least partial impairment of a detection by a respective sensor of the sensors may be established for one or for multiple of the sensors;
c) adapting the use of the sensor data taking the checking from step b) into account.

2. The method as recited in claim 1, wherein one or multiple of the sensors are camera sensors.

3. The method as recited in claim 1, wherein the checking in step b) takes place based on a comparison of detections by different sensors of the sensors.

4. The method as recited in claim 1, further comprising:
providing at least one piece of information about:
a selected sensor data stream, and/or
an established impairment of the detection, and/or
a position of a sensor of the sensors for a main data path changed due to the selection.

5. The method as recited in claim 1, wherein the sensors are two optical sensors of a stereo camera.

6. The method as recited in claim 1, wherein the sensor data or sensor data streams are processed at least partially separately from one another.

7. The method as recited in claim 1, wherein the system is a system for at least semi-assisted and/or automated driving.

8. A non-transitory machine-readable memory medium on which is stored a computer program for processing sensor data in a system that includes multiple sensors for detecting at least one subarea of surroundings around the system, the computer program, when executed by a computer, causing the computer to perform the following steps:
a) reading in sensor data detected at least partially in parallel by the sensors;
b) checking, on the basis of the read-in sensor data, whether an at least partial impairment of a detection by a respective sensor of the sensors may be established for one or for multiple of the sensors;
c) adapting the use of the sensor data taking the checking from step b) into account.

9. A system, comprising:
multiple sensors configured for an at least partially parallel detection of at least one subarea of surroundings around the system;
one or multiple units configured to check, based on sensor data detected by the sensors, whether an at least partial impairment of a detection by a respective sensor of the multiple sensors may be established for one or for multiple of the sensors;
a unit configured to select a main sensor data stream or sensor data stream for a main data path.
